(19) United States
(12) Patent Application Publication
(10) Pub. No.: US 2024/0407889 A1
(43) Pub. Date: Dec. 12, 2024

(54) METHOD FOR MONITORING FOR FAILURE OF AN ENDODONTIC INSTRUMENT

(71) Applicant: MICRO-MEGA INTERNATIONAL, BESANCON (FR)

(72) Inventors: Rachid RAHOUADJ, NANCY (FR); Marin VINCENT, LAY-SAINT-CHRISTOPHE (FR); Rémy BALTHAZARD, SAINT-MAX (FR); Marie DEVALLOIR, BESANCON (FR)

(73) Assignee: MICRO-MEGA INTERNATIONAL, BESANCON (FR)

(21) Appl. No.: 18/697,621

(22) PCT Filed: Sep. 27, 2022
(86) PCT No.: PCT/FR2022/051821

§ 371 Date: Apr. 1, 2024

(30) Foreign Application Priority Data
Oct. 1, 2021 (FR) FR2110434

(51) Int. Cl. A61C 5/48; A61C 1/10; A61C 5/40

(52) U.S. Cl. CPC A61C 5/48; A61C 1/10; A61C 5/40

(57) ABSTRACT

A method for monitoring a failure of an endodontic instrument used during an endodontic treatment during which the instrument is driven by a handpiece and generates a set of acoustic emission signals, remarkable in that the method includes the steps of: sensing and analysing all of the acoustic emission signals generated by use of the instrument; and when a failure of the instrument occurs, thus generating a failure acoustic emission signal, detecting the failure acoustic emission signal amongst the set of acoustic emission signals in order to detect the occurrence of the failure.

### FIELD

The invention relates to the technical field of endodontics, and in particular to that of prevention of incidents in the endodontic field.

### BACKGROUND

During an endodontic treatment, an instrumental breakage is one of the most frequent complications. The direct complications of this instrumental breakage are clinical:
if it is possible to recover the instrument shatter, the consequences are an increase in the duration of the treatment and a potential weakening of the tooth by a reduction in the residual wall thickness necessary for removal thereof;
if it is not possible to recover the instrument shatter, the consequences could (i) be related to an insufficient disinfection of the canal network resulting in post-operative pain, non-healing and therefore a failure of the endodontic treatment or (ii) be related to the apparition of an infectious process not existing at the time and leading to treatment failures and failures in the mid and long term.

In general, the occurrences of instrumental breakages are reduced by the design of the canal instruments, in order to make them more resistant to the stresses exerted during the endodontic treatment. However, the breakage factors are not limited only to the characteristics of the instrument: the manner in which the practitioner uses it, or the shape of the canal to be treated are major parameters.

In order to limit the excessive stresses undergone by the instrument, some handpieces, driving the instrument, are provided with devices for controlling the torque exerted by the motor on the instrument, or enable a real-time measurement of the operating parameters of the instrument. However, this type of instantaneous measurements does not allow preventing all types of breakages, such as fatigue or creep breakages.

In particular, in the case of the treatment of a root canal having an elbow, i.e. a very large curvature and with a reduced radius, the rotary bending that the instrument undergoes could lead to an almost-instantaneous breakage. Thus, the breakage of the bending-torsion instrument might occur at values of mechanical stresses, such as torque, largely below the limit of the maximum ones rated by the manufacturer.

In the case of reusable instruments, the stresses and the degradations that the instrument undergoes accumulate and are not taken into account in this type of instantaneous analysis. Hence, instrumental breakages might occur.

### SUMMARY

One of the aims of the invention is to provide a method for monitoring an endodontic instrument, in order to detect the occurrence of a failure as early as possible.

To this end, a method has been developed for monitoring a failure of an endodontic instrument used during an endodontic treatment during which the instrument is driven by a handpiece and generates a set of acoustic emission signals.

According to the invention, the method is remarkable in that it comprises steps of:
sensing and analysing all of the acoustic emission signals generated by use of the instrument during shaping of a root canal for example;
when a failure of the instrument occurs, thus generating a failure acoustic emission signal, detecting said failure acoustic emission signal amongst the set of sensed and analysed acoustic emission signals in order to detect the occurrence of the failure.

The failures occurring within the instrument may be of different natures. These may consist of structural failures, such as:
the apparition of a crack or of a breakage initiation within the material forming the instrument, and likely to lead to a breakage;
a local plastic deformation, which could result in an untwisting or an excessive twisting of the instrument;
the change in the crystalline structure of the material, for example a transformation from austenite into martensite. This change in the crystalline structure modifies the mechanical behaviour of the instrument and could lead to breakage of the instrument depending on the clinical situation.

These may also consist of practical failures, such as:
a stuffing the helical grooves defined between the cutting lips of the instrument, filled by the accumulation of cutting debris and preventing the proper operation of the instrument;
an excessive mechanical load that the practitioner applies to the instrument, beyond the stresses for which the instrument has been designed.

In turn, the acoustic emission signals consist of energy releases in the form of transient elastic waves which accompany various evolutive processes, sometimes irreversible. In this case, the evolutionary processes may for example consist in:
stressing the constituent material of the instrument;
displacing dislocations within the material, for example in the case of a plastic deformation;
the apparition, then the propagation of a crack or a breakage initiation on a microstructural or geometric defect.

Hence, the method according to the invention allows identifying the failures occurring within the instrument, before breakage thereof when it is a structural or design failure. For example, detecting the apparition of a crack, synonymous with imminent breakage of the instrument, allowing being informed thereon prior to breakage of the instrument. It is subsequently possible to stop the use of the instrument on time.

As breakages and ruins could be avoided, the complications of the cares will also be so, since the practitioner could replace the instrument or adapt his/her protocol according to the endodontic treatment to be carried out.

In a preferred embodiment, the step of detecting the failure acoustic emission signals consists in comparing acoustic emission signal parameters with models of failure acoustic emission signals recorded beforehand in a database and/or with respect to predetermined thresholds. In this manner, the analysis and processing times are reduced, and the chances of recognising the failure acoustic emission signals within the set of sensed acoustic emission signals are optimum.

Advantageously, after having detected the failure, and in particular the initiation and the development of the failure modes, the method comprises a step of identifying from among a list of possible failures established with regards to models of failure acoustic emission signals recorded beforehand in a database and/or with regards to predetermined thresholds. Thus, the practitioner is provided with more information on the types of encountered failures. This information may be transmitted to the manufacturer of the instrument in order to be taken into account in a continuous improvement approach.

Preferably, after having detected the failure, the method comprises a step of emitting an alert signal so that the practitioner is warned on the occurrence of the failure, and therefore on the imminent breakage of the instrument.

The invention also relates to a method for controlling a handpiece driving an endodontic instrument during an endodontic treatment, and implementing the monitoring method according to the aforementioned technical features. This method is remarkable in that it consists in adapting drive parameters of the instruments according to the identified failure. Thus, the practitioner is assisted in his/her gesture when the failure occurs. If the breakage is imminent, driving of the instrument may be stopped. If the breakage is not imminent, driving of the instrument may be adapted so as to safely continue the care, while prolonging the service life of the instrument.

In one embodiment, the practitioner enters beforehand a complexity score of the treatment to be performed, for example if the root canal to be treated has a complex geometry, and the adaptation of the drive parameters is adjusted, or weighted, according to this complexity score of the treatment. This allows increasing the safety margin in the case of risk treatments, during which the breakage of the instrument is more likely if a failure occurs.

The invention also relates to a device for implementing the method according to the aforementioned features, and remarkable in that it comprises:
a sensor for sensing acoustic emission signals generated by the instrumental dynamics during the canal shaping, such as an ultrasonic sensor;
acoustic analysis means configured to detect a failure acoustic emission signal from among the set of acoustic emission signals, in order to detect the occurrence of a failure of the instrument.

In this manner, the device comprises the essential means for an efficient implementation of the described method.

Advantageously, the analysis means are configured to identify the failure from among a list of possible failures established with regards to models of failure acoustic emission signals recorded beforehand in a database and/or with regards to predetermined thresholds, in order to reduce the processing times and to maximise the chances of recognition of the failure acoustic emission signals within the set of sensed acoustic emission signals.

The invention also relates to a handpiece for driving an endodontic instrument, comprising a device according to the aforementioned features as well as alert means. In this manner, the handpiece comprises the essential elements for the implementation of a failure detection, and is configured to warn the practitioner in the event of a failure.

Advantageously, the handpiece comprises a programmable interface connected to the acoustic analysis means, and the programmable interface is configured to adapt dynamics parameters of the instrument according to the identified failure. Thus, the invention is perfectly integrated into the equipment that the practitioner uses in a conventional manner, and its use is natural for the practitioner.

According to possible embodiments:
the acoustic emission sensor is arranged inside a body of the handpiece; in order to be arranged proximate to the instrument, and the handpiece is a complete kit; and/or
the acoustic emission sensor is outside a body of the handpiece, and is configured to be coupled on the tooth or proximate to the tooth of the patient; in order to be less sensitive to the acoustic emission signals emitted within the handpiece.

### BRIEF DESCRIPTION THE DRAWINGS

FIG. 1 is a block diagram illustrating the method according to the invention.

FIG. 2 is a diagram illustrating the characteristics of an acoustic emission.

FIG. 3 is a graph illustrating correlation models.

FIG. 4 is another block diagram illustrating the method according to the invention.

### DETAILED DESCRIPTION

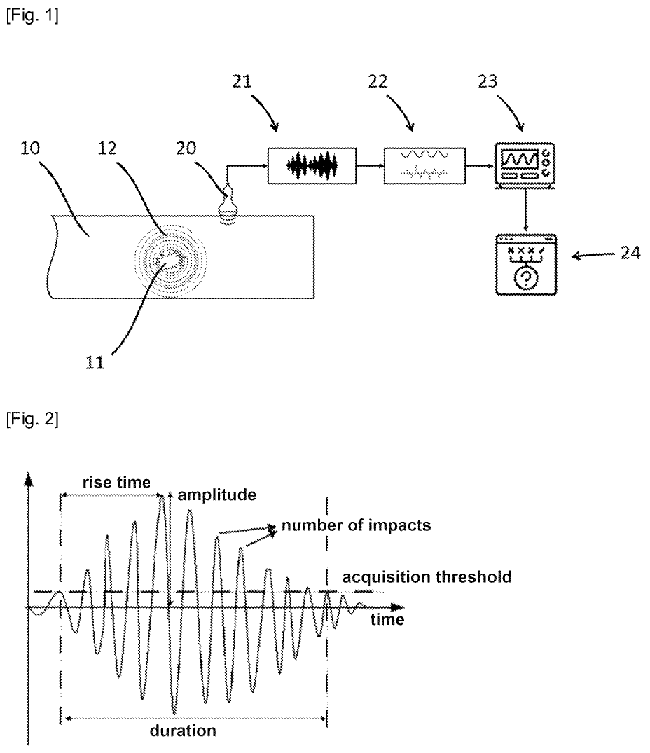

Referring to FIGS. 1 to 4, the invention relates to a device for detecting a failure occurring within a canal instrument (10) during an endodontic treatment, a device implementing such a method, and a handpiece driving a canal instrument (10) and comprising such a device. For example, the endodontic instrument is a canal instrument, commonly so-called a file, including a blade comprising a plurality of helical cutting lips. For example, the instrument is driven in vibration, in back-and-forth movements, in simple rotation, in alternating rotation, or any other drive type.

FIG. 1 illustrates the principle of the analysis of the acoustic emission signals emitted within an instrument (10). During use thereof, the instrument (10) undergoes mechanical stresses such as bending, torsion, combined bending/twisting. When the constituent material of the instrument (10) is under stress, it emits acoustic emission signals, not shown for legibility of the figures. In general, these acoustic emission signals are located in the ultrasound range, i.e. their frequencies are generally higher than 20 KHz.

[In addition, the mechanical frictions within a handpiece driving the instrument (10), the machining that the instrument carries out within the canal as well as the motor of the handpiece are examples of acoustic emission and noise sources.

During use of the instrument (10), a failure (11) of the instrument (10) might appear. For example, it may consist of a plastic deformation area, or the apparition of a crack. This failure (11) will emit a failure acoustic emission signal (12) upon apparition thereof. The signal will propagate within the material of the instrument (10), then, by contact, within the other parts with which the instrument (10) is in contact. The parts comprise, inter alia, the bore in which the instrument (10) is mounted, or the treated tooth.

The method according to the invention consists in:
sensing and analysing the acoustic emission signals generated by use of the instrument (10), i.e. the acoustic emission signals of the handpiece, as well as the parasitic noises, and the failure acoustic emission signal (12);
within the set of sensed acoustic emission signals, detecting the failure acoustic emission signal (12) in order to detect the occurrence of the failure (11).

In practice, an acoustic emission signal sensor (20) is arranged on, or proximate to, the instrument (10). Preferably, it consists of a piezoelectric sensor, mounted at the surface of a part of the endodontic environment. There should then be a mechanical continuity between the instrument (10) and the location where the sensor (20) is arranged, i.e. the parts between the instrument (10) and the sensor (20) should touch in order to conduct the elastic waves of the acoustic emissions emitted by the instrument (10), and in particular the failure acoustic emission (12).

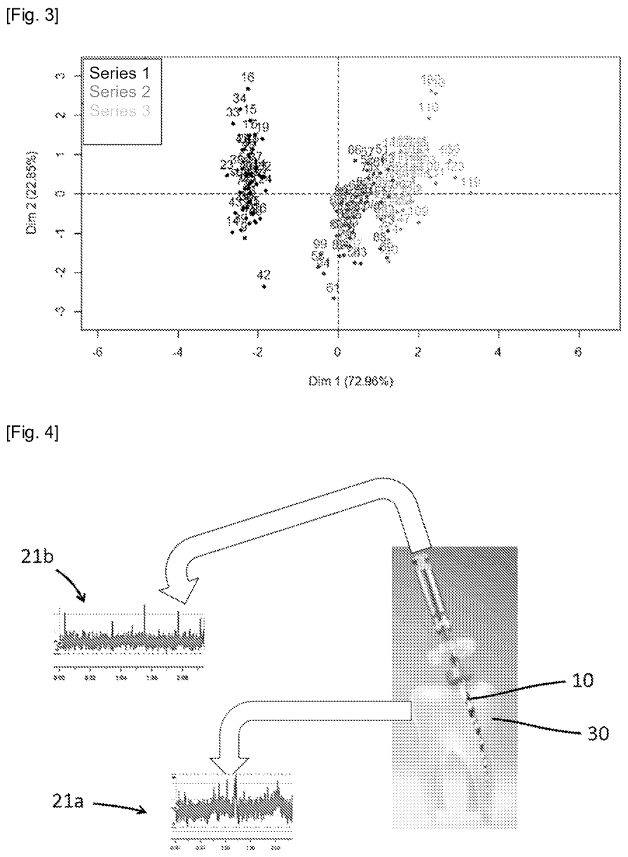

Referring to FIG. 4, the sensor (20) could therefore be arranged:
on the treated tooth, or proximate thereto. Hence, the sensor (20) is immediately proximate to the instrument (10), and is less subjected to the acoustic emission originating from the handpiece. In this case, the sensed acoustic emission signals bear the reference (21a) in FIG. 4.
inside a handpiece comprising the means for implementing the described method. Although the sensor (20) is more subjected to the acoustic emission signals originating from the handpiece, it is not necessary to install the sensor (20) in the mouth of the patient. Hence, the preparations are reduced and the treatment is easier to implement. In this case, the sensed acoustic emission signals bear the reference (21b) in FIG. 4.

The location of the sensor (20) has an impact on its perception of the acoustic emissions, also the signals of the sensed emissions (21a, 21b) are different.

In some embodiments, there are several sensors (20), so that the location of the failure could be determined by triangulation. Multiplying the sensors (20) also allows making the signal obtained reliable, by redundancy and information confrontation. Hence, there could be a sensor (20) within the handpiece and another sensor (20) arranged on, or proximate to, the treated tooth, or several sensors (20) in the mouth or in the handpiece.

In order to perfect the transmission of the elastic waves between the sensor (20) and the part on which it is mounted, the sensor (20) may be coupled, for example with a gel, in order to reduce, and possibly suppress the air layer between the sensor (20) and the part on which it is mounted.

The sensor (20) senses all of the acoustic emission signals and the noise of the endodontic medium. Hence, the sensed signal should be processed in order to be able to facilitate analysis thereof as well as the recognition of a failure acoustic emission signal (12) within the set of sensed acoustic emission signals.

To this end, the processing generally comprises the following steps:
a pre-amplification, allowing increasing the amplitude of some components of the set of sensed acoustic emission signals and improving the signal-to-noise ratio;
a filtering, in order to suppress noise and some acoustic emission signals not corresponding to a failure, and possibly to isolate some components of the set of acoustic emission signals on the basis of parameters or characteristics of the sensed acoustic emissions;
an amplification in order to improve the signal for processing thereof;
the final processing performed by acoustic analysis means (24), and allowing detecting and possibly identifying the failure acoustic emission signal (12).

In practice, these steps are respectively implemented by:
a pre-amplifier (21);
a filter (22);
an amplifier (23), such as a measurement amplifier;
acoustic analysis means (24), by execution of an algorithm or a program executed by a computer. This means that the acoustic analysis means (24) comprise a computer-readable medium, on which the computer program is recorded, the latter comprising the lines of code allowing executing the desired acoustic analysis.

Since the method according to the invention allows recovering as much physical and mechanical information as possible on the conditions of use of the instrument (10), it is possible, thanks to the performed data processing, to monitor tissue machining conditions in real-time, and to monitor the mechanical response of the treated tissue as well as its surrounding environment, etc.

For example, as regards the deformation of the instrument (10), the constituent material of which is generally a shape-memory alloy, the deformation could be accompanied by a phase transition between the austenite phase and the martensite phase involving a given number of variants, and which will be accompanied by a specific acoustic energy release, in the ultrasound range.

As regards the machined tissue, it is subjected to localised plasticisation because of the formation of chips, which also produce an ultrasonic acoustic emission.

Advantageously, the elements allowing implementing the method are included in a device adapted for implementing the described method, so that it is possible to equip dental surgery practices regardless of the care equipment that they already have.

In a preferred embodiment, this device is included in a handpiece driving the instrument (10). Thus, the elements essential for the implementation of the method are the closest to the instrument (10). Moreover, the device can cooperate more easily with other elements of the handpiece, such as a programmable interface of the handpiece.

The acoustic analysis means (24) are configured to detect a failure acoustic emission signal (12) according to the characteristics of the set of sensed acoustic emission signals.

Referring to FIG. 2, the characteristics of an acoustic emission signal may be, yet without being limited to:
its frequency;
its RMS voltage;
its amplitude;
its rise time;
its count rate
its cumulated count.

For example, on signals with a particular frequency within the set of acoustic emission signals, crossing a predetermined threshold is interpreted by the acoustic analysis means (24) as being a failure acoustic emission signal (12).

The same principle applies for example to the combination of a voltage RMS, a count rate, or a cumulated count.

In order to facilitate and accelerate the processing of the sensed signal, the recognition of a failure acoustic emission signal (12) is performed by comparing the parameters of the sensed acoustic emission signals with models of failure acoustic emission signal (11) recorded beforehand in a database.

Obtaining these pre-recorded models requires the completion of destructive tests on instruments (10), under conditions of use the closest to the real conditions, and during which all of the acoustic emission signals are recorded.

When the number of tests is great and the population of the samples is sufficient, by proceeding with a multi-dimensional statistical analysis of the data, it is possible to detect the correlations that exists between some failures and the types of sensed acoustic emission signals. Referring to FIG. 3, a schematic illustration of multi-dimensional statistical analysis of the data is shown revealing the correlation of three clouds of points each forming a particular series, in projection according to two selected dimensions (for example, with the first dimension being the frequency, and the second dimension being the rise time).

This multi-dimensional statistical data analysis method allows, for a given instrument (10) type, acquiring a model of failure acoustic emission signals (12) for each of the investigated and tested failures (11).

Of course, the expected failure (11) type, as well as the characteristics of the emitted failure acoustic emission signal (12), vary according to the considered instrument (10) type: indeed, the material choice may be different from one instrument (10) type to another. The same applies for example for the geometry, the dimension, the drive parameters and the distribution of the masses.

Thus, the acquisition of the models should be done for each type of instrument (10) for which the invention is to be implemented.

Preferably, the pre-recorded acoustic emission models of a range of endodontic instruments (10) are registered in a database, which could be interrogated by the acoustic analysis means (24), or by the programmable interface of the handpiece.

In order to obtain as much information as possible on the conditions of use as well as on the different modes of breakage of the instrument (10), once the occurrence of a failure (11) is detected, the method according to the invention further comprises a step of identifying the type of the failure (11). In the same manner as for the detection, the identification is performed by comparison with pre-recorded models or by comparison with predefined thresholds.

This information may be made available to the practitioner, in particular so that he/she adapts his/her practice in the context of failures (11) related to the practice. For example, it may consist of a tendency to press too much on the instrument (10) during a reduced cutting efficiency following the accumulation of debris in the grooves of the instrument.

This information may also be made available to the manufacturer of the instrument (10) so that it could begin continuous improvement steps if it notices that a particular failure (11) type occurs too often.

In these cases, the acoustic analysis means (24) are connected to any suitable display or data transmission means, and the acoustic analysis means (24) execute a computer program suited to implement said display and transmission.

In one embodiment, when the failure (11) is detected, the method then comprises a step of emitting an alert signal. Hence, the practitioner is warned on the danger of breakage weighing on the instrument (10) and could therefore interrupt his/her use on time. If the method comprises a step of identifying the failure (11), the alert signal could be adapted according to the failure (11) type.

Preferably, the handpiece driving an endodontic instrument (10) during endodontic treatment is controlled by a method capable of identifying the type of failure (11) that has occurred, and of adapting the drive parameters of the instrument (10) according to the identified failure (11).

In this manner, the method could for example:
interrupt the rotation of the instrument (10) if breakage is imminent;
decrease the rotational speed or the torque applied to the instrument (10) if breakage is not imminent and the service life of the instrument (10) could still be prolonged.

In practice, a handpiece according to the invention comprises a programmable interface connected to the acoustic analysis means (24), and the programmable interface is configured to adapt parameters of the instrument (10) according to the identified failure.

Advantageously, this programmable interface enables the practitioner to enter beforehand a complexity score of the treatment to be accomplished. If the treatment is complex and the risk of breakage is high, the adaptation of the drive parameters of the instrument (10) is adjusted accordingly: the gains are weighted relative to the risk of breakage, rather than trying to maximise the service life of the instrument (10). The drive parameters of the instrument are even more reduced for safety.

The reverse approach could also be considered in the case of a simple treatment.

The method according to the invention actually allows detecting the occurrence of a failure (11) within an instrument (10) used during the treatment of a root canal. Consequently, this detection method allows preventing breakage of the instrument (10), which would result in clinical complications.

Moreover, the method, the device and the handpiece may be shaped differently from the description and the figures without departing from the scope of the invention, which is defined by the claims.

Furthermore, the technical features of the above-mentioned different embodiments and variants may, for all of them or for some of them, be combined with one another. Thus, the method, the device and the part may be adapted in terms of cost, functions and performance.

1-12. (canceled)

13. A method of monitoring failure of an endodontic instrument used in endodontic treatment during which the instrument is driven by a handpiece and generates a set of acoustic emission signals, wherein the method comprises the steps of:
capturing and analyzing the set of acoustic emission signals generated by the use of the instrument;
when a failure of the instrument occurs, thereby generating a failure acoustic emission signal, detecting said failure acoustic emission signal among the set of acoustic emission signals captured and analyzed in order to detect the occurrence of the failure.

14. The method according to claim 13, wherein the step of detecting a failure acoustic emission signal comprises:
comparing acoustic emission signal parameters with failure acoustic emission signal patterns previously stored in a database;
comparing acoustic emission signal parameters with respect to predetermined thresholds; or
comparing acoustic emission signal parameters both with failure acoustic emission signal patterns previously stored in a database, and with respect to predetermined thresholds.

15. The method according to claim 14, wherein the method comprises, after having detected the failure, a step comprising identifying a failure from a list of possible failures established:
with reference to failure acoustic emission signal patterns previously stored in a database;
with reference to predetermined thresholds; or
both with reference to failure acoustic emission signal patterns previously stored in a database and with reference to predetermined thresholds.

16. The method according to claim 13, wherein the method comprises, after having detected the failure, a step consisting in emitting an alert signal.

17. A method of controlling a handpiece driving an endodontic instrument during endodontic treatment, wherein the method implements the monitoring method of claim 15, and comprises adapting instrument dynamics parameters according to the identified failure.

18. The method according to claim 17, wherein the adaptation of the instrumental dynamics parameters is adjusted according to a treatment complexity score previously captured by a practitioner.

19. A device for implementing the method of claim 13, wherein the device comprises:
a sensor of a set of acoustic emission signals which are generated by the instrumental dynamics; and
acoustic analysis means configured to detect a failure acoustic emission signal from the set of acoustic emission signals, in order to detect the occurrence of a failure of the instrument.

20. Device according to claim 19, wherein the analysis means are configured to identify the failure from a list of possible failures established:
with reference to failure acoustic emission signal patterns previously stored in a database;
with reference to predetermined thresholds; or
both with reference to failure acoustic emission signal patterns previously stored in a database and with reference to predetermined thresholds.

21. A handpiece for driving an endodontic instrument, wherein the handpiece comprises a device according claim 19 as well as warning means.

22. The handpiece according to claim 21, wherein:
the handpiece comprises a programmable interface connected to acoustic analysis means, the programmable interface is configured to adapt instrument dynamics parameters as a function of the identified failure;
the analysis means of the device are configured to identify the failure from a list of possible failures established:
with reference to failure acoustic emission signal patterns previously stored in a database;
with reference to predetermined thresholds; or
both with reference to failure acoustic emission signal patterns previously stored in a database and with reference to predetermined thresholds.

23. The handpiece according to claim 21, wherein the sensor is arranged inside a body of the handpiece.

24. The handpiece according to claim 21, wherein the sensor is outside a body of the handpiece and is configured to be coupled to the patient's tooth, or near the tooth.
